(19) United States
(12) Patent Application Publication
(10) Pub. No.: US 2014/0070504 A1
(43) Pub. Date: Mar. 13, 2014

(54) Expandable mobile display sales cart

(71) Applicants: Douglas Scott Martin, New Castle, PA (US); Melinda Lyle Martin, New Castle, PA (US)

(72) Inventors: Douglas Scott Martin, New Castle, PA (US); Melinda Lyle Martin, New Castle, PA (US)

(21) Appl. No.: 13/573,375

(22) Filed: Sep. 12, 2012

(51) Int. Cl. B62B 3/10

(52) U.S. Cl. CPC B62B 3/10
USPC 280/47.35

(57) ABSTRACT

An expandable mobile display sales cart that has two positions: mobile/storage position and display position. The cart design allows multiples of the carts to be used together. The cart can be placed in the mobile/storage position that permits the contraction of the cart to a minimal footprint floor space where many carts can be transported in a condensed environment. The display position allows the expansion of the cart where many carts can be arranged in different configurations for the easy viewing, browsing and purchasing of the product by the customer. The cart has a shelf unit with a slide and lock system that allows the shelf unit to be contracted and locked substantially to the center of the cart to provide a stable and condensed footprint for mobility, reducing the overall size of the cart, and expanded and locked for the display position.

The mobile/storage footprint allows storage of multiple carts in a minimal space. By removing the fabric slipcover, the mobile/storage position's condensed footprint provides access to the product that is still in the original placement position on the cart, allowing easy locating of the product to pull for shipping Internet orders and the restocking of the cart with existing and new products. The display position can easily and quickly be obtained after relocating each cart to the desired new placement configuration by removing the fabric slipcover, unlocking, expanding, and relocking the shelf unit in the expanded display position, and unlocking the lower container crates so they can be pulled out for viewing the product contained therein. After expanding the carts to the display position, the product on display is already in the correct position for easy viewing, browsing and purchasing by the customer. The use of multiple carts allows the display of a very large amount of various products for the consumer to purchase.

### CITED REFERENCES

U.S. Pat. No. 4,159,831 Frederick D Schorr

U.S. Pat. No. 3,879,053 William J. Chvala

U.S. Pat. No. D224,059 Melvin O. Maisak

U.S. Pat. No. D219,720 Melvin O. Maisak

U.S. Pat. No. 4,034,572 Herbert R. Morris

U.S. Pat. No. 3,295,634 Henry M. Buchbinder

U.S. Pat. No. 5,718,441 Alan R. Kern

U.S. patent application Ser. No. 11/593,489 Miles Anthony Konopka

U.S. Pat. No. 4,411,367 Rafael T. Bustos

U.S. Pat. No. 4,793,497 Don Hall

U.S. Pat. No. 3,690,118 Julius H. Rainwater

U.S. Pat. No. 3,628,807 William H. Fullington

U.S. patent application Ser. No. 10/335,607 Gene Ronald LeClere

U.S. Pat. No. 6,460,950 Christopher G. Spitzer

U.S. Pat. No. 6,951,283 Troy S. Savole

U.S. Pat. No. 3,260,561 Isidore Trakman

U.S. Pat. No. D247,081 Charles L. Davis

U.S. Pat. No. D318,194 James Terrell

U.S. Pat. No. D277,626 Jonathan M. Evans

U.S. Pat. No. 7,766,348 Scott McFarland

U.S. Pat. No. D344,419 David C. F. Stoddard

U.S. Pat. No. 1,959,926 Walter A. Reich

### No Federal Sponsored R&D

### BACKGROUND OF THE INVENTION

The present invention generally relates to a cart for display of product. More specifically, the present invention relates to a cart for a retail environment that expands to a display position to display product in the cart for easy viewing, is mobile for moving and transporting, contracts to a condensed footprint for mobility/storage position allowing the transportation of multiple carts in a minimal space while maintaining the product securely in the cart. Furthermore, the condensed footprint allows storage of the carts in a minimal space at an original base location and still provides access to the products on the cart. The expandable display position can be used in either the retail environment or the original base environment. Both the display position and mobile/storage position reduce product damage, reduce time for set up and repacking, and reduce labor costs. Additionally, the design allows for significantly more products to be displayed within the footprint of the cart.

The expandable mobile display sales cart (hereafter referred to as “cart”) is primarily used in the scrapbooking industry for holding products to display for sale and/or for storage of these products. The cart has casters that provide easy mobility of the cart with the product, and has container crates and a movable shelf unit that allows the expansion of the cart for display and contraction of the cart size for the safe movement of the cart.

The display position would be used in any environment such as a retail space, a hotel, a convention center, a home, etc,—any environment that allows a customer to view, browse and purchase product from the cart. This position can also be at the original base location for Internet sales, adding new product, and restocking existing product. This significantly increases the ability to set up at one- or multiple-day events at different locations displaying a vast amount of product.

The mobile/storage position has a contracting shelf unit permitting a greatly reduced footprint minimizing space requirements while providing great stability by moving the weight closer to the center of the cart for movement and transporting and allowing multiple carts to be transported in a significantly reduced space without having to remove or rearrange the product on the cart. The cart in the mobile/storage position can be easily rolled on its casters into any vehicle with ramp/lift/platform loading capabilities and transported to any location. The condensed footprint greatly reduces the cost requirements to transport multiple carts. The mobile/storage position's condensed minimized footprint permits the storage of multiple carts in significantly reduced space environment with or without product.

The mobile/storage position still allows full access by an individual to pull orders for shipping, delivery, and for restocking product back into the cart or adding new products. The full access of the cart in the mobile/storage position is accomplished by the design of the platforms that slide in and out and the container crates that can slide forward providing convenient and immediate access to the product when the cart is in the mobile/storage position.

By using an alternate configuration of the cart, a private Individual can have a cart that provides the same storage capabilities in a compact space that provides easy and convenient storage, viewing, browsing and selecting of the products. The shelf unit is stationary to the main cart and the shelves can be reconfigured as needed. All of the container crates can slide in and out to allow easy and convenient assess to the products. The width of the cart can be variable determined by the number of crates across.

The cart can be used in either a commercial business or by a private individual. The commercial business would use the cart to display products for sale and for storage. An individual would use the cart in their dwelling for storage of scrapbooking or other products for their personal use. This cart would hold products for use or sale, such as printed paper, coordinating embellishments, packaged kits, tools, supplies and other products for the scrapbooking industry, but this design is not limited to this industry and can be modified to meet criteria of any industry.

It is common in the scrapbooking industry for individuals and/or companies to sponsor events for the scrapbooker outside of the retail store environment. It is desirable to have a vendor(s) at these events to display products for sell. In the common situation, vendors generally bring product in containers and bins by either hand carrying the containers or using dollies, etc. This method presents a significant compromise between the quantity of product that can be brought and the time, cost and labor to set up at the event and take back to the original base location. There can be additional cost involved if they must rent tables or other display equipment. Additionally, they cannot display as much product in the same footprint as the cart because they must spread their product out over a larger space. The invention has been designed to overcome these limitations.

Merchandising units have been developed for the mobility and display of product. Some units have been designed around the profile of the product to better display the product; therefore, the unit design is specific to the product and has a particular location on the unit for the display of that product. The specifics of the design can include moving display drawers to provide better viewing of the product and top and intermediate shelving that extend up and down for storage and display of the product. The units can be loaded with the product and transported but are limited in displaying large quantities of a vast variety of products and/or limited to displaying only a particular line of product. More often, after the unit gets to a location, it will remain there at that location.

Other times, the unit will be transported to a new location but when the transportation includes multiply units, there must be ample space to hold all the units. Other unit designs are general in nature with shelving that is repositionable to accommodate different varieties and sizes of products but after the loading of the product, the shelving position remains stationary to that position for displaying the product. These units are transportable but the product is not secured in place and therefore can fall over and/or get out of position, requiring rearranging of the product for display at the new location. When transporting multiples of these units, there must be ample space. As the number of units in use increases, the setup time to prepare the units for display and the breakdown time to prepare the units for transporting also greatly increases. Additional time is required to rearrange any and all products that may have shifted during transportation and moving to the new location. Should any of these aforementioned units return to an original base location for whatever reason, there must be ample room to accommodate multiple units.

Therefore, a need currently exists for an expandable mobile display sales cart that provides a condensed footprint permitting minimal space requirements for multiple carts during transportation that can be easily moved to different locations, that provides the same condensed footprint in the mobile/storage position while still allowing full access to the product, and that has an expandable position for displaying the products either at a retail environment and/or the original base environment that allows easy viewing, browsing and purchasing of the product by the consumer and/or restocking or placing new products in the carts. The design provides locking of the expandable components of the cart for transporting the carts to different locations and maintaining the product in a secure manner so that it stays in the original placement position so that the product is immediately ready for display when the cart is relocated to a retail environment and/or original base location. The cart design allows multiple carts to be used for the transporting, display, and storage of the product so that a large variety of products can be on display for the consumer to purchase. Furthermore, the cart design is general enough in nature to accommodate differerent sizes of products and a very large variety of products. Additionally, the cart design provides a significant reduction in the time, cost and labor to setup up multiple units for display and preparing the multiple units for transportation.

The mobile cart in this invention is its own display system, capable of displaying a large amount of product in a small space with a minimal amount of setup time and capable of collapsing to a smaller footprint for transportation.

### SUMMARY OF THE INVENTION

The present invention relates to an expandable mobile display cart (hereafter referred to as “cart”) with an objective to display multiple products to consumers for viewing, browsing and purchasing. It is another objective of the invention to provide a cart that expands to a full display position, thus allowing easy viewing, browsing and purchasing by the consumer, but also contracts to a mobile/storage position that provides a greatly reduced minimal footprint to permit the use of multiple carts and the transportation and storage of multiple carts in a condensed environment. It is another objective of the invention to provide a cart that when in the mobile/storage position still provides full access to the product. It is another objective of the invention to provide a cart that allows the product to maintain the original position on the cart during moving and transporting the carts in the mobile/storage position to different locations. It is another objective of the invention to provide a cart that as the quantity of carts in use increases, the design simplifies the expansion set-up time at a new location and simplifies the condensing time back to the mobile/storage position, greatly reducing the time and labor required to accomplish both. It is another objective of the invention to provide a cart with casters that is easily movable by being pushed by an individual, easily transportable to different locations, and provides a hook location for alternately moving the carts with a motorized puller. It is another objective of the invention to provide a cart that has a frame and a shelf unit where the shelf unit can be contracted to the general center location of the frame to provide a stable condensed footprint, minimizing the space requirements of the cart in the mobile/storage position. This minimized footprint allows more carts to be loaded in a given space and/or stored in a given space. The carts can be easily rolled on the casters up a ramp or onto a lift gate and loaded into the transportation vehicle or device such as a shipping container or railcar. When the shelf unit is expanded to the display position, this position allows immediate full viewing of product on the cart. It is another objective of the invention to provide a cart that has a platform on the middle level that extends from the front of the cart to provide immediate full viewing of product residing on the platform and/or in a container crate on the platform.

The cart generally includes a frame that is on casters for easy moving, has a lower tabletop surface with containment rails, a middle beam that includes a platform, and allows for a container crate to be secured to the platform. The platform pulls outward on slides from the front of the cart, and the platform can be locked securing the platform in the closed position. The upper tabletop surface can be used to display product and/or have a container crate(s) positioned on it. The container crate's position is maintained by the containment rails and the shelf stabilizer plate. A shelf unit is attached to the frame by the slides. The shelf unit is composed of vertical shelf legs, several horizontal shelves attached to the shelf legs, a shelf stabilizer plate attached to each shelf leg, a backing brace attached to the back sides of the vertical shelf legs and horizontal shelves, slides attached to the shelf legs, and optional support legs that can be positioned at the underside back edge of the vertical shelf legs. The shelf unit has a slipcover that is placed over the shelf unit and tied securing the slipcover to the shelf unit to maintain the product on the shelf unit in place during moving and transporting the cart.

Preferably, the cart lower tabletop surface, the platforms, container crates, the upper tabletop surface and the shelves are stocked with product with the option of placing product in bins. When the cart is in the mobile/storage position with the slipcover removed, full access is available to the carts lower tabletop surface, the platforms, container crates, the upper tabletop surface and the shelves. The platforms and/or lower container crates are accessible by unlocking the platform locks to allow the platforms and/or lower container crates to be pulled forward to the full extension of the slides. The upper crates are accessible by removing the front containment rail and sliding the upper container crate forward on the upper tabletop surface out from underneath the shelf unit to gain full assess to the upper container crate. This full assess provides the ability to maintain multiple carts in the mobile/storage position in a minimized footprint reducing the space requirements and still allowing access to product for Internet orders. Alternately, it is understood that upper container crates could also be on the full extension slides to facilitate this access and have a locking system similar to that of the platform, but this alternative is not shown. The shelf unit remains locked in the mobile/storage position with full access to the horizontal shelves. The fully stocked cart with the lower platforms locked, shelf unit locked and slipcover secured to the shelf unit is now ready for moving and transporting to any location.

When the carts arrive at the new location for a retail sales activity, the design of the carts allows for the ability to be arranged in multiple configurations to fit the space of the location. After the carts have been rolled to the configuration for the new location, the carts can then be expanded to the display position for viewing, browsing and purchasing the products by the consumer. To expand the carts to the display position, first the slipcover is removed and placed in storage to be used again later. Second, the locking pins in the slides for the shelf unit are removed and the shelf unit is slid back with the full extension slides opening to the expanded position. Then the locking pins are placed back into the slides to lock the shelf unit in the fully extended position. Placing the locking pin back in the slides to lock the slides secures the shelf unit and makes it stable for consumers to remove, view and replace product or product bins from and to the horizontal shelves. Third, the platform locks are unlocked to allow full expansion of the full extension slides of the platform. Alternately, the leg supports that have a foot that is adjustable for height can be placed underneath the backside of the vertical shelf legs with the foot against the ground to add additional support to the shelf unit. The design has allowed the product to remain in place during the transportation of the carts, and with the carts now in the expanded display position the retail sales activity can begin. In addition to holding a variety of products, the crates were designed to hold a group of matching papers inside clear plastic sleeves that are open at the top for easy removal of one or more of the papers. The sleeves can be tilted forward or backward, pivoting from the bottom at approximately a 25-degree angle in either direction or lifted up to view both sides of the paper. The sleeves protect the product from soiling or getting damage while individuals are browsing through the papers. The design has greatly reduced the set-up time and labor required to accomplish the set-up from the mobile/storage position to the display position.

Again the time and labor is greatly reduced to change the carts back to the mobile/storage position from the display position. The process initially starts by locking the platform locks then minimally moving a cart to access the locking pins on the shelf unit slides and removing the locking pins. Next the shelf unit is slid forward contracting the slides until the shelf unit is again approximately centered over the frame, then replacing the locking pins back into the shelf unit slides to lock the shelf unit in place. The slipcover is placed over the shelf unit and securely tied. The cart is now in the mobile/storage position, in the reduced and minimized stable footprint, and ready to be moved and transported to a new location or back to the original base location.

The height locations of the carts lower tabletop surface, the platforms, lower container crates, upper container crates, the upper tabletop surface and the shelves are positioned so that an individual of average height can easy view, retrieve and replace product to the cart.

### BRIEF DESCRIPTION OF THE DRAWINGS

The drawings illustrate the best mode presently contemplated of carrying out the invention. In the drawing:

FIG. 1 is a perspective view illustrating the expandable mobile display sales cart in the display position.

FIG. 2 is a top view illustrating the expandable mobile display sales cart in the display position.

FIG. 3 is a front view illustrating the expandable mobile display sales cart in the display position.

FIG. 4 is a side view illustrating the expandable mobile display sales cart in the display position.

FIG. 5 is a back view mobile display sales cart in the mobile/storage position:

FIG. 6 is a perspective view illustrating the expandable mobile display sales cart in the mobile/storage position.

FIG. 7 is a top view illustrating the expandable mobile display sales cart in the mobile/storage position.

FIG. 8 is a front view illustrating the expandable mobile display sales cart in the mobile/storage position.

FIG. 9 is a side view illustrating the expandable mobile display sales cart in the mobile/storage position.

FIG. 10 is a bottom view illustrating the expandable mobile display sales cart in the mobile/storage position.

FIG. 11 is a back view illustrating the expandable mobile display sales cart in the mobile/storage position.

FIG. 12 is a top view illustrating multiple expandable mobile display sales carts in the mobile/storage position loaded inside a trailer.

FIG. 13 is a top view illustrating the expandable mobile display sales cart in the mobile/storage position.

FIG. 14 is a top view illustrating the expandable mobile display sales cart in the display position.

FIG. 15 is a perspective view illustrating the expandable mobile display sales cart in the display position.

FIG. 16 is a perspective view illustrating the expandable mobile display sales cart in the display position with one platform opened.

FIG. 17 is a bottom view illustrating the expandable mobile display sales cart in the mobile/storage position.

FIG. 18 is a close-up side view illustrating the expandable mobile display sales cart in the display position shown the locking pin

FIG. 19 is a side view of the locking pin parts.

FIG. 20 is a perspective view illustrating the expandable mobile display sales cart in the mobile/storage position with the slipcover secured to the cart.

### DETAILED DESCRIPTION OF THE INVENTION

In describing the preferred embodiment of the current invention illustrated in the drawings, specific terminology will be used to describe the illustrations for clarity. However, the invention is not intended to be limited to the specific terminology so selected, and it is to be understood each specific terminology includes all technical equivalents that operate in a similar manner to accomplish a similar purpose.

The cart in the current design is predominantly constructed of wood that is painted. It is understood that the cart could be constructed of any other material such as aluminum that can be treated by anodizing or coating as desired to an individual's color preference. The cart in the preferred embodiment being constructed of wood requires brads, nails, screws and/or glue to assemble the cart. The term “attached” will mean the use of brads, nails, screws and/or glue to secure parts together.

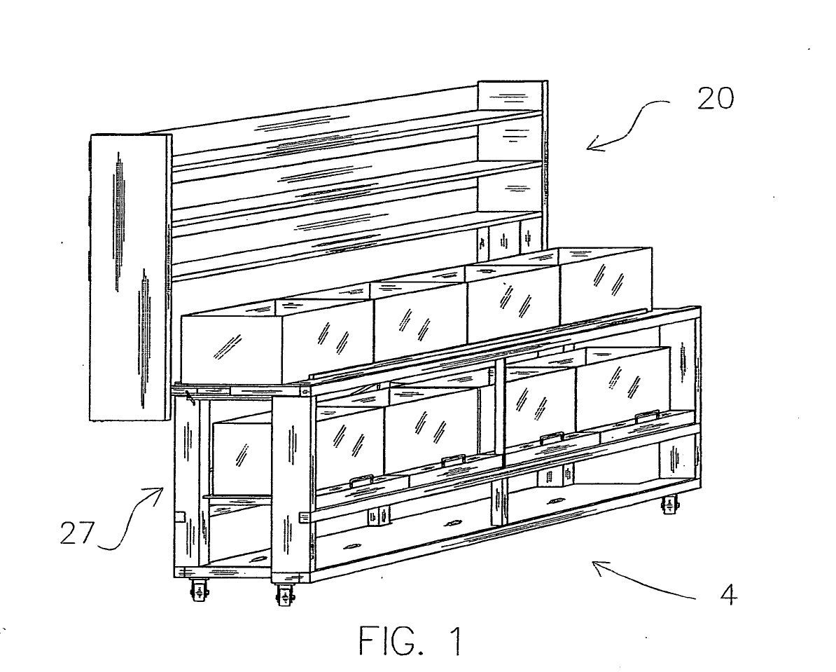

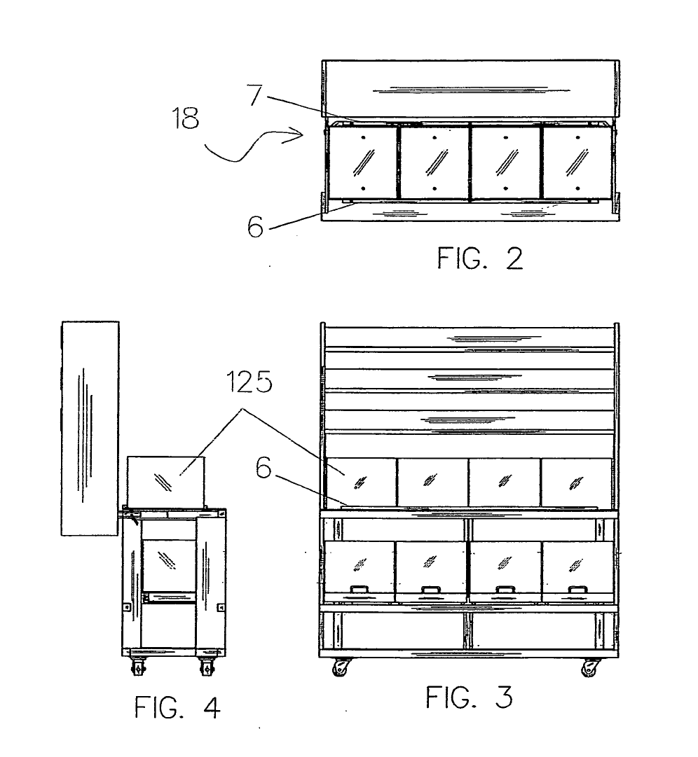

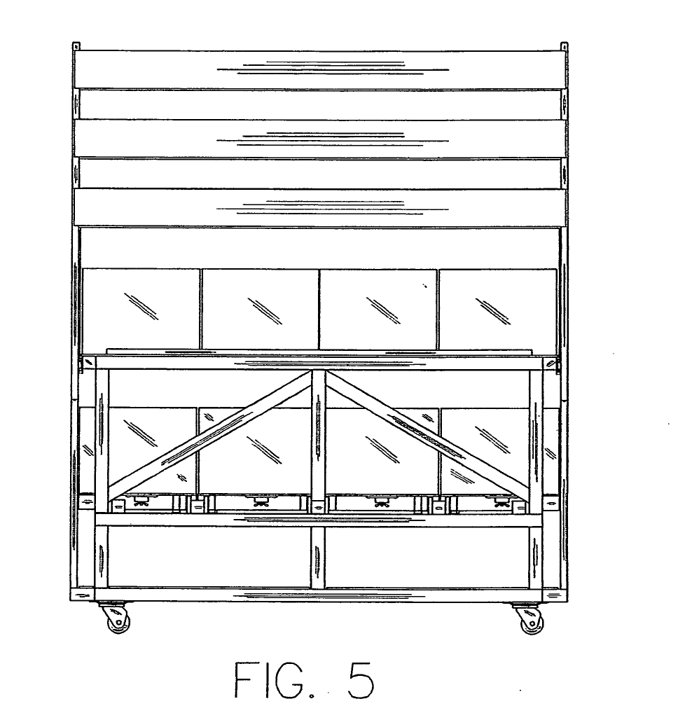

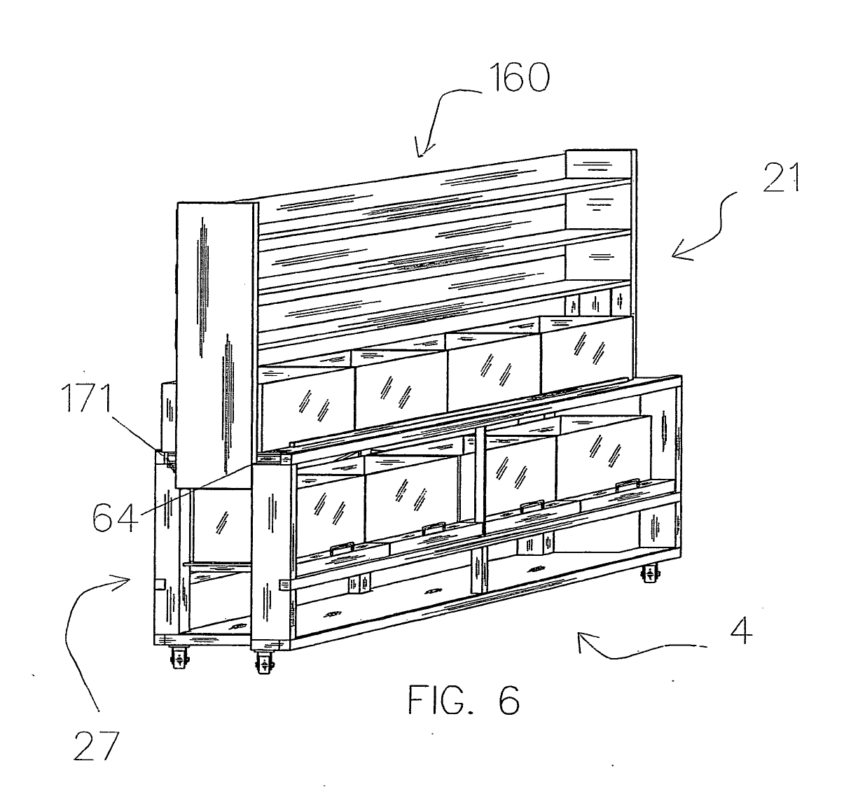

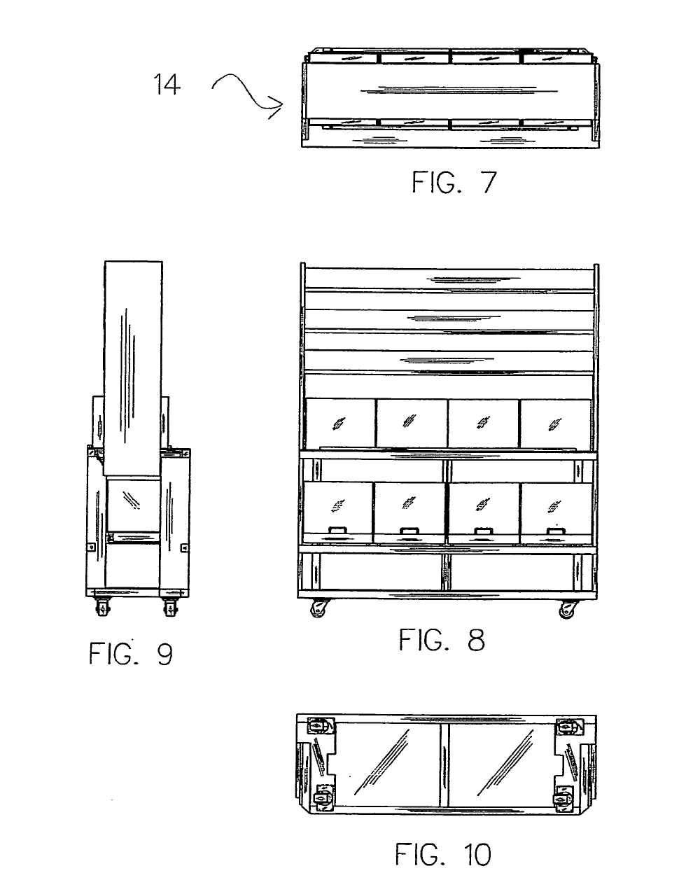

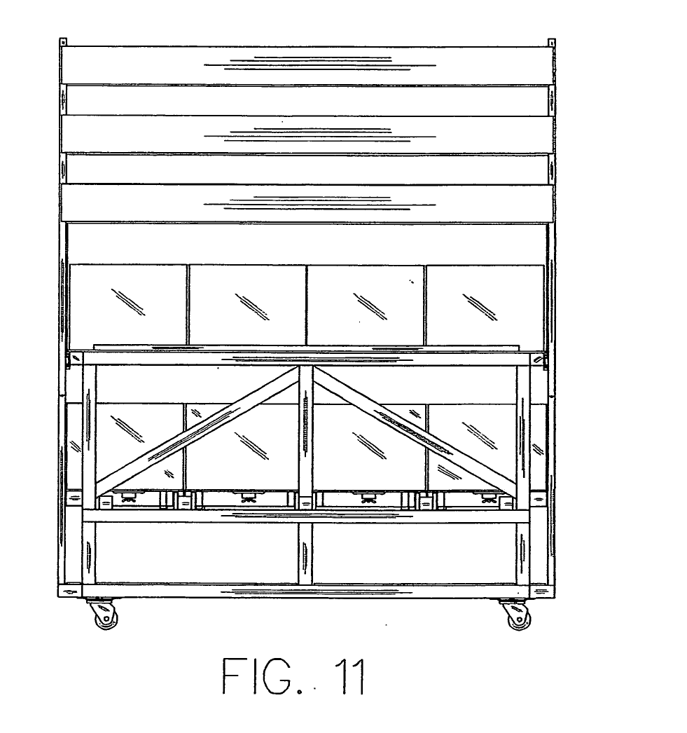

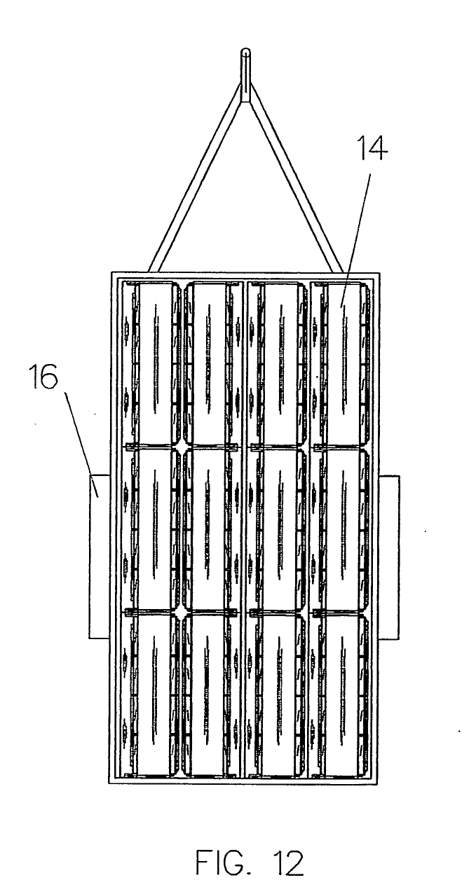

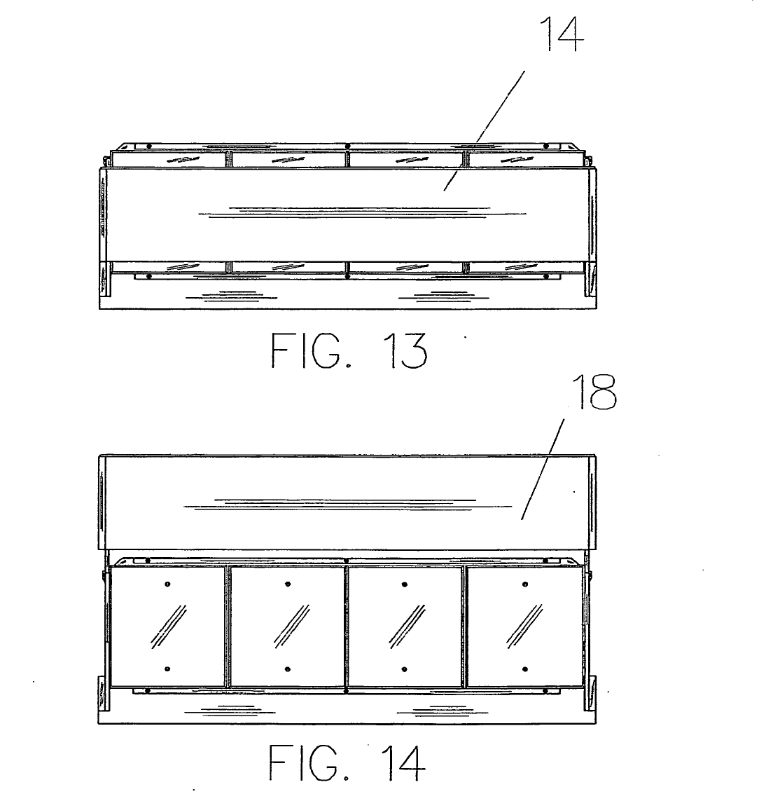

FIG. 1 shows the display position 20 of the cart 4. The display position 20 of the cart 4 is further illustrated in FIG. 2 of the display position top view 18, FIG. 3 the display position front view, FIG. 4 display position side view, and FIG. 5 the display position back view. FIG. 6 shows the mobile/storage position 21 of the cart 4. The mobile/storage position 21 of the cart 4 is further illustrated in FIG. 7 showing the mobile/storage position top view 14, the mobile/storage position front view FIG. 8, mobile/storage position side view FIG. 9, mobile/storage position bottom view FIG. 10, and back view FIG. 11. The invention allows multiplies of cart 4 to be used. FIG. 12 shows the loading of twelve carts of the mobile/storage top view 14 shown in FIG. 7, loaded into a transporting vehicle as a 7′ W by 14′ L trailer 16. It can be seen from FIG. 13 that the mobile/storage position top view 14 provides a minimized condensed footprint of nearer to half the size of the display position top view 18 of FIG. 14, therefore permitting more carts to be transported within a given space and permitting more carts to be stored in a given space in the mobile/storage position 21 shown in FIG. 6.

FIG. 2 and FIG. 3 show the containment rails 6 and 7. The containment rails hold the container crates 125 in place during movement and transportation. Containment rail 6 can be removed to allow container crate 125 to be pulled forward to provide access to the container crate 125 when the cart 4 is in the mobile storage position 21.

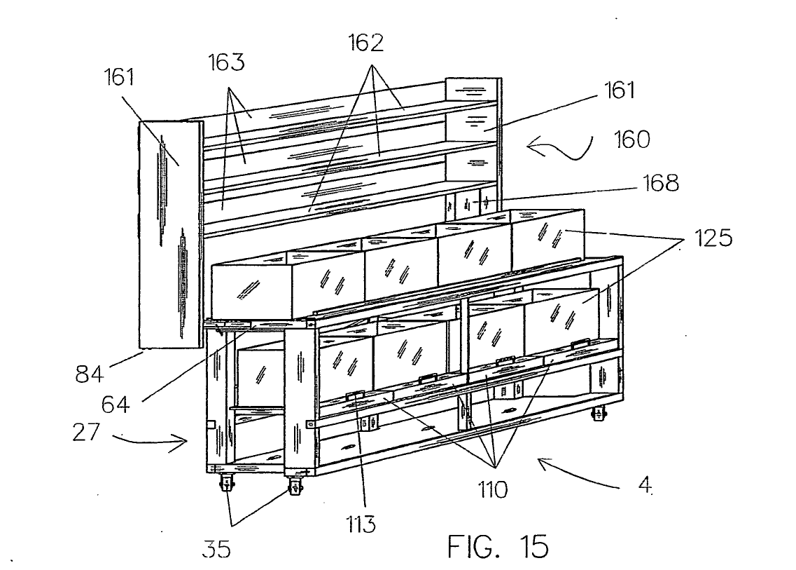

Referring back to FIG. 15, the cart 4 has a frame 27, a shelf unit 160, container crates 125, and a platform 110 with handles 113. The shelf unit 160 has shelf legs 161 that are approximately 41″ long×11″ wide×0.75″ deep. The shelves 162 are approximately 51″ long×11″ wide×0.75″ deep. The shelves 162 are attached to the shelf legs 161 with the top shelf approximately 5″ from the top surface Shelf leg 161. The middle shelf is spaced approximately 8″ from the top shelf and the bottom shelf is spaced approximately 8″ from the middle shelf. The back braces 163 are approximately 51″ long 4″ high× 3/16″ deep and are attached to the backside of the shelves 162 and shelf legs 161. The back braces 163 provide structural support to the shelf unit 160 and prevent product from falling off the back of the shelf unit 160. The shelf slides 64 are attached to the inside surface shelf legs 161 and are approximately 4″ from the bottom surface of shelf legs 161. As shown in FIG. 6, the shelf slides 64, in the contracted position permit the shelf unit 160 to be positioned generally to the center of the frame 27 to provide a condensed minimal footprint for the cart. As shown in FIG. 15, when the shelf slides 64 are expanded to the full open position, the shelf unit 160 moves beyond the back of the frame 27 permitting full access to the container crates 125. Shelf stabilizer plates 168 are attached to the inside surface Shelf legs 161 and against the bottom surface shelves 162. The Shelf stabilizer plates 168 rest on the top surface of shelf slide 64 in the mobile/storage position to stabilize the shelf unit 160 during movement and transportation and help protect the shelf slide 64 mechanics from any major vibrations or shock movements that can occur during transportation. The bottom surface of shelf legs 161 has two foot-locator screws 84 attached. The casters 35, a commercially available caster providing 360-swivel rotation, are attached to the bottom of frame 27.

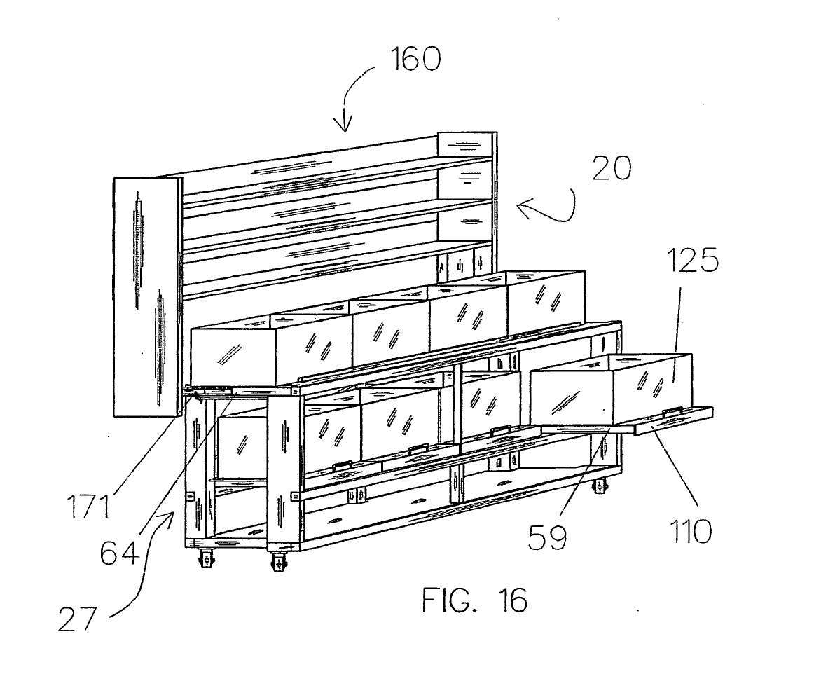

As shown in FIG. 16, the platform slides 59 attached to the platform 110 can be pull to the full open position to provide viewing of the product in crates 125.

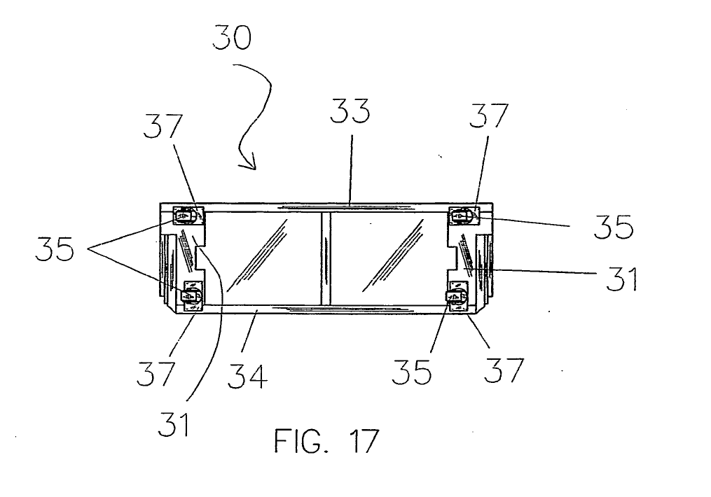

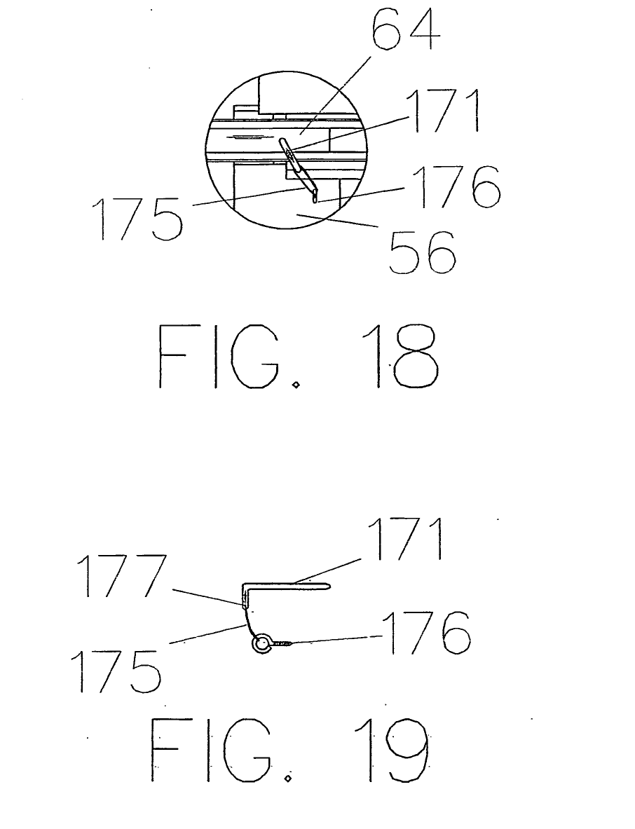

In FIG. 17, the casters 35 are positioned so that the mounting plate 37 of the casters 35 straddles across the caster cross brace 31 and the front base beam 33 and rear base beam 34 providing full support to both the caster cross brace 31 and the base beams 33 and 34 for a strong base section 30.

As shown in FIG. 16, the locking pins 171 are inserted through the shelf slides 64 and into frame 27 to lock the shelf unit 160 in the display position 20. When the locking pins are removed, the shelf unit 160 can slide to be positioned to the general center of the frame 27. As shown in FIG. 6, the shelf unit 160 can be locked in the mobile/storage position 21 by placing the locking pins 171 back into the same hole of frame 27 at the end of shelf slides 64 to hold the shelf unit locked in the mobile storage position 21.

FIG. 18 is a close up view of the locking pin 171 in shelf slide 64. FIG. 19 shows the locking pin 171 with eyelet screw 176 and elastic band 175. The elastic band 175 is threaded and looped through both the band hole 177 in the locking pin 171 and the eyelet screw 176. The eyelet screw 176 is secured to the rear pillar leg 56. The elastic band 175 provides tension so that the locking pin 171 does not vibrate loose during movement and transportation of the cart 4. The elastic band also maintains the locking pin in close proximity of the shelf slide for quick accessibility and preventing it from getting lost when switching the shelf unit 160 between the display position 20 and the mobile/storage position 21.

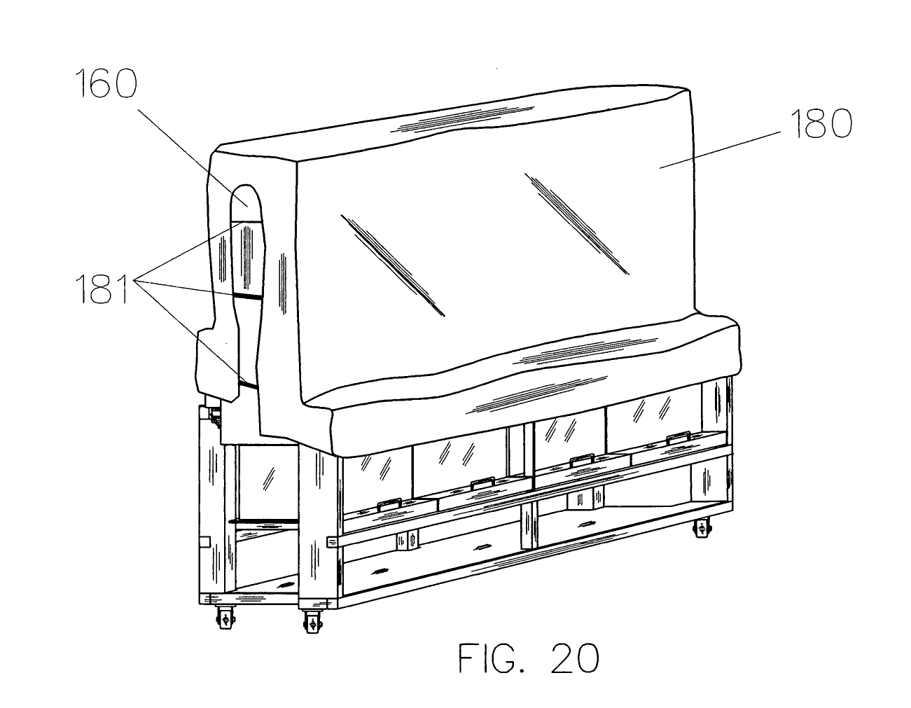

As shown in FIG. 20, a slipcover 180 with tye strings 181 can be place over the shelf unit and the tye strings tied to secure the slipcover 180 to the shelf unit. This holds the product and/or product bins in place on the shelf unit 160 during moving and transportation. The slipcover 180 can be easily an quickly placed onto and tied to secure to the shelf unit 160 greatly reducing set-up time and labor. By holding the product and/or product bins in location, the cart product is immediately ready for sales activity after the removal of the slipcover because the product and or product bins have remained in place during the transportation process.

The foregoing description and drawing should be considered as illustrative only of the principals of the invention. The invention configuration illustrated is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

We claim:

1. An improved mobile storage and display cart, comprising:
(a) a base portion having an underside with a plurality of wheels mounted thereon;
(b) a plurality of frame supports extending upwardly from said base portion;
(c) a plurality of table top surfaces having a general flat top surface attached to the said frame supports;
(d) a shelf unit that is attached to said frame supports;
(e) said shelf unit having a plurality of shelves that is attached to said shelf unit;

2. The invention of claim 1, wherein said shelf unit is movable forward and back in relation to said base portion.
(a) A plurality of locking pins maintains said shelf unit to a fixed said forward position and a fixed said back position.

3. The invention of claim 1, wherein a plurality of containers are positioned on the top of said tabletop surfaces;
(a) Said containers comprise a bottom, generally vertical side walls and are open at the top:

4. The invention of claim 3, wherein said containers are movable forward and back in relation to said base portion.
(a) A plurality of securing systems maintains said containers on said tabletop surface in a fixed home position whereas unlatching said securing systems allows said containers to be freely moved between said home position and an open position;

5. The invention of claim 4, wherein multiples of said mobile storage and display cart can be used.

6. An improved mobile storage and display cart, comprising said containers wherein said containers maintain product placed inside plastic sleeves.
(a) Said plastic sleeves are open at the top;

7. An improved mobile storage and display cart, comprising:
(a) a base portion;
(b) a plurality of frame supports extending upwardly from said base portion;
(c) a plurality of table top surfaces having a general flat top surface attached to the said frame supports;
(d) a shelf unit that is attached to said frame supports;
(e) said shelf unit having a plurality of shelves that is attached to said shelf unit;

8. The invention of claim 7, wherein a plurality of containers are positioned on the top of said tabletop surfaces;
(a) Said containers comprise a bottom, generally vertical side walls and are open at the top:

9. The invention of claim 8, wherein said containers are movable forward and back in relation to said base portion;
(a) A plurality of securing systems maintains said containers on said tabletop surface in a fixed home position whereas unlatching said securing systems allows said containers to be freely moved between said home position and an open position;
